(19) United States
(12) Patent Application Publication
(10) Pub. No.: US 2007/0284122 A1
(43) Pub. Date: Dec. 13, 2007

(54) Systems for Aerating Soil

(76) Inventor: Timothy Bowman, Cartersville, GA (US)

Correspondence Address: THOMAS, KAYDEN, HORSTEMEYER & RISLEY, LLP, 600 GALLERIA PARKWAY, STE 1500, ATLANTA, GA, 30339, US

(21) Appl. No.: 11/692,604

(22) Filed: Mar. 28, 2007

Related U.S. Application Data
(60) Provisional application No. 60/813,202, filed on Jun. 13, 2006.

(51) Int. Cl. A01B 45/02

(52) U.S. Cl. 172/21

(57) ABSTRACT

An exemplary embodiment comprises a plurality of aerating members with each aerating member having two opposing end portions, an aerating portion, an inner surface, and an outer surface. The end portions of the aerating members being angled with respect to the aerating portion. A plurality of linking members are moveably coupled with fasteners to the end portions such that an alternating series of linking members and aerating members form a loop of such members for attaching to a tire. A plurality of stud members are attached to the aerating portion of the aerating members.

### CROSS-REFERENCE TO RELATED APPLICATION

This application is a utility application that claims priority to co-pending U.S. Provisional Patent Application entitled, “Mow-Aerator”, having Ser. No. 60/813,202, filed Jun. 13, 2006, and co-pending U.S. Provisional Patent Application entitled, “Systems for Aerating Soil”, filed Mar. 19, 2007 via Express Mail, no. EV628220731 US, which are entirely incorporated herein by reference.

### TECHNICAL FIELD

The invention relates to lawnmowers and aerating systems for lawn mowers.

### BACKGROUND

Soil aeration allows air and water to enter the soil and contact the root systems of grass under the surface of the soil. This process results in a healthier lawn.

The majority of soil aeration is accomplished by the use of expensive commercial machinery dedicated to the task of soil aeration. These machines may aerate soil by driving holes in the soil or pulling out plugs of the soil. Use of such machines for performing soil aeration is inefficient for a number of reasons. For example, purchasing an aeration machine can be costly. Additionally, the use of a dedicated aeration machine requires subjecting a lawn to two passes, one while mowing the lawn, and a second while aerating the soil. Finally, there are millions of existing lawnmowers that are not designed to aerate soil. It is desirable that there be an apparatus that can easily fit on existing lawnmowers with out having to make substantial modifications to the lawnmowers. Prior machines used to both cut grass and aerate soil use complicated designs that are expensive to implement.

### SUMMARY OF THE INVENTION

Systems for aerating soil are provided. In this regard, an exemplary embodiment comprises a plurality of aerating members with each aerating member having two opposing end portions, an aerating portion, an inner surface, and an outer surface. The end portions of the aerating members being angled with respect to the aerating portion. A plurality of linking members are moveably coupled with fasteners to the end portions such that an alternating series of linking members and aerating members form a loop of such members for attaching to a tire. A plurality of stud members are attached to the aerating portion of the aerating members.

Another exemplary embodiment of such a system comprises a lawnmower having a plurality of wheels, each of the wheels having a tread surface and side wall surfaces. An aerating apparatus engaging at least one of the plurality of wheels. The aerating apparatus comprising a plurality of aerating members each aerating member having end portions, an inner surface and an outer surface. The inner surfaces are in contact with the tread surfaces, the end portions are in contact with the side wall surfaces. The aerating members are moveably coupled with a plurality of linking members and fasteners. A plurality of stud members are attached to the outer surface of the aerating members.

Other systems, methods, features, and/or advantages of the present invention will be or may become apparent to one with skill in the art upon examination of the following drawings and detailed description. It is intended that all such additional systems, methods, features and/or advantages be included within this description and protected by the accompanying claims.

### BRIEF DESCRIPTION OF THE DRAWINGS

Many aspects of the invention can be better understood with reference to the following drawings. The components in the drawings are not necessarily to scale. Additionally, like reference numerals designate corresponding parts throughout the several views.

FIG. 1 is a perspective view illustrating an exemplary embodiment of a system for aerating soil.

FIG. 2 is a perspective view of a wheel to which an exemplary embodiment of a system for aerating is attached.

FIG. 3 is a view of an exemplary embodiment of a threaded linkage.

FIG. 4 is a view of an exemplary embodiment of a threaded stud removed from an aerating portion.

FIG. 5 is a perspective view of a wheel to which an exemplary embodiment of a system for aerating is attached.

FIG. 6 is a perspective view of a wheel to which an exemplary embodiment of a system for aerating is attached.

FIG. 7 shows an embodiment of an aerating system using a lawnmower.

### DETAILED DESCRIPTION

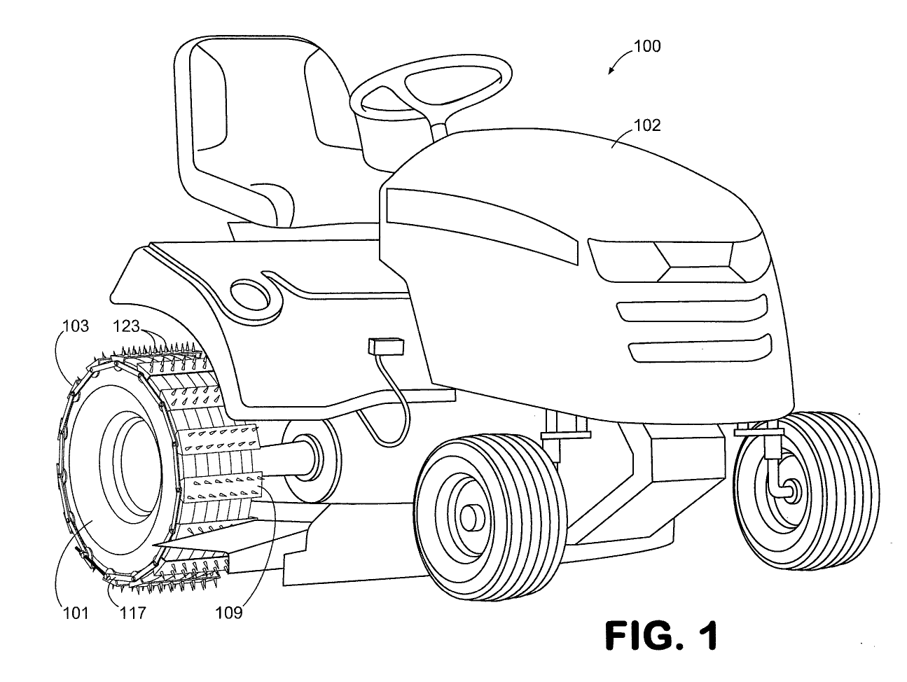

Systems for aerating soil are provided. Referring now in detail to the drawings, FIG. 1 is a perspective view illustrating an exemplary embodiment of a system 100 that incorporates a lawnmower and an aerating apparatus. In particular, the lawnmower 102, in this case, a riding lawnmower, has a wheel 101 engaged with an aerating apparatus 103. Those skilled in the art will understand that the aerating apparatus 103 may be used with a riding lawnmower, push lawnmower, tractor, or any other device that may use wheels to traverse a lawn.

The aerating apparatus 103 comprises a plurality of aerating members 109 linked together. The aerating members 109 are engaged by studs 123 and connected by linking members 117. The aerating members 109 engage the wheel 101 of the lawnmower 102. As the lawnmower 102 is driven on a lawn to cut grass, the aerating apparatus 103 drives holes in the soil with studs 123. These holes thereby allow air and water to contact the roots of grass resulting in healthier grass.

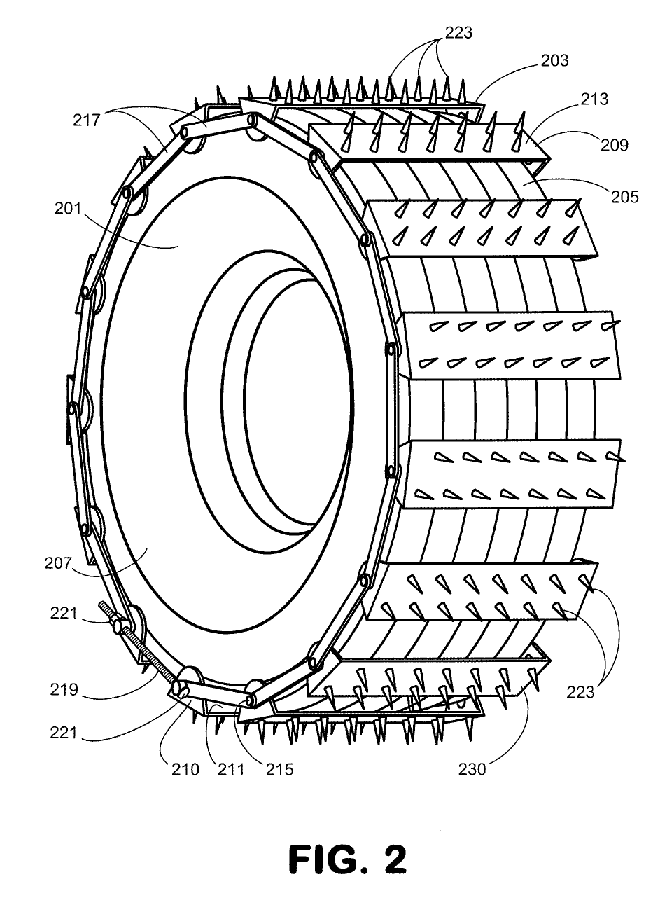

FIG. 2 is a perspective view of wheel 201, with sidewall 207 and tread surface 205 engaged with an embodiment of an aerating apparatus 203. Those skilled in the art understand that the tread surface 205 may have one of a variety of known tread patterns, or may be substantially smooth with no tread pattern. Aerating apparatus 203 comprises: a plurality of aerating members 209 having end portions 210, an aerating portion 230, an inner surface 211, and an outer surface 213. In this embodiment, the end portions 210 of each aerating member 209 are angled to be substantially perpendicular to the aerating portion 230 so that the inner surface 211 contacts the sidwalls 207 of the wheel 201. In this embodiment, each of the end portions 210 define a hole (not shown) so that a fastener 215 may be used to attach linking members 217 that link one aerating member 209 to another aerating member 209.

Linking a plurality of aerating members 209 together using the linking members 217 and fasteners 215, will result in an aerating apparatus 203 of sufficient length to fit the tread surface 205 of the wheel 201. The aerating apparatus 203 may be secured to the wheel 201 using threaded linking members 219. The threaded linking members 219 may engage the aerating apparatus 203 at end fasteners 221 that have a threaded bore (not shown) that receives the threaded fastener 219.

A user installs the aerating apparatus 203 by placing the aerating apparatus 203 on a wheel 201 so that the inner surfaces 211 of the aerating members 209 contact the sidewall 207 and the tread surface 205. A user turns the threaded linking members 219 using their hands or an appropriate tool (not shown) so that the aerating apparatus 203 is a length approximate to the length of the tread surface 205 of the wheel 201. The user may tighten the threaded linking members 219 so that the aerating apparatus 203 engages the wheel 201 without slipping while the wheel 201 is driven on soil.

The aerating member 209 has a plurality of studs 223 attached to the aerating portion 230. The studs 223 in this embodiment are in the shape of spikes. However, one skilled in the art would understand that the shape of the studs 223 is not limited to spikes and may include, as a non-limiting example, studs in a hollow shape that cut plugs in the soil, studs that have a rounded tip, substantially flat studs, or studs in a mushroom shape.

Once assembled and installed on the wheel 201 of a lawnmower (not shown), the aeration apparatus 203 may aerate the soil by driving holes into soil by means of the studs 223.

In operation, the end portions 210 are in contact with the sidewalls 207 of the wheel 201. The end portions 210 are operative to keep the aerating portion 230 aligned with the tread surface 205 of the wheel 201. As the lawnmower is driven on soil, the weight of the lawnmower acts to drive the studs 223 into the soil, thereby resulting in holes in the soil. In one embodiment, the linking members 217 may rotate on an axis substantially perpendicular to the fasteners 215. This rotation allows the aerating members 209 to move when force from the weight of the lawnmower is applied.

A person of ordinary skill in the art will understand that the aerating apparatus 203 may be assembled in a number of different configurations. For example, the aerating members 209 and the linking members 217 may be fabricated in a variety of shapes and dimensions in order to fit different sized and types of wheels or lawnmowers. Additionally, the aerating members 209 may not have a hole on each end to accommodate a fastener 215, but may have for example, a threaded stud or other type of fastener attached to the outer surface 213 of the aerating member 209.

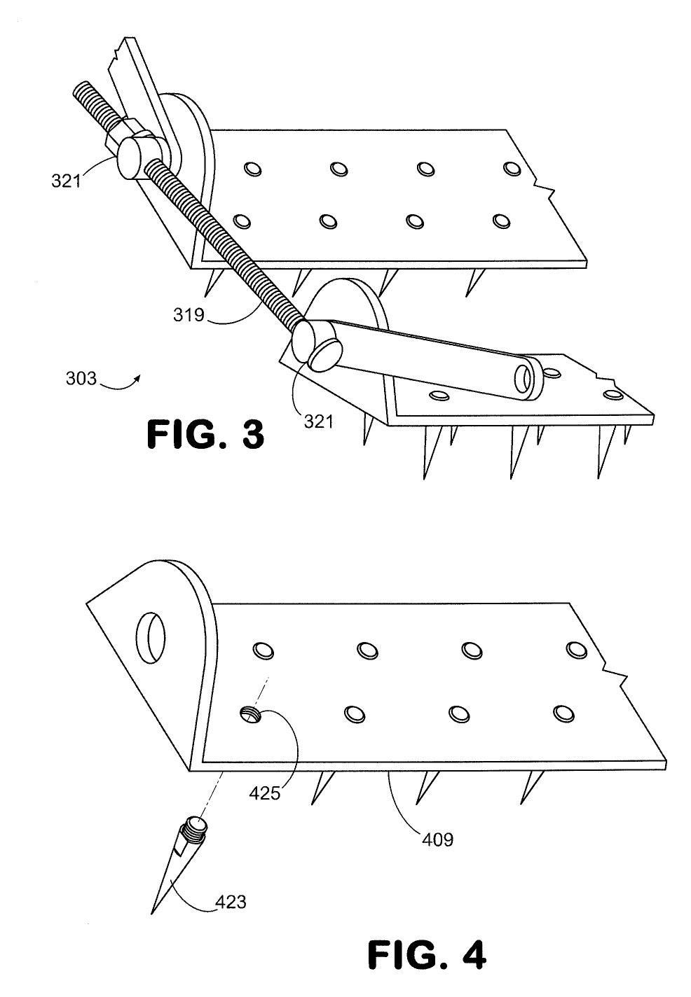

FIG. 3 shows the threaded linking members 319 engaging the end fasteners 321. The threaded linking members 319 may be rotated so that the distance between the end fasteners 321 may be adjusted. A threaded linking member 319 is used along both the inside and outside sidewalls of the wheel 301 (not shown). The removal of the threaded linking members 319 from the aerating apparatus 303 allows for the removal of the aerating apparatus 303 from the wheel 201 (not shown). One skilled in the art will understand that the threaded linking members 319 may be different lengths and types depending on the requirements of the embodiment.

FIG. 4 shows how, in one embodiment, the studs 423 may be removed from aerating member 409 by unscrewing the studs 423 from the threaded holes 425 in aerating member 409. This allows the studs 423 to be interchangeable. However one skilled in the art would realize that in alternate embodiments, the studs 423 may be permanently fixed to the aerating member 409.

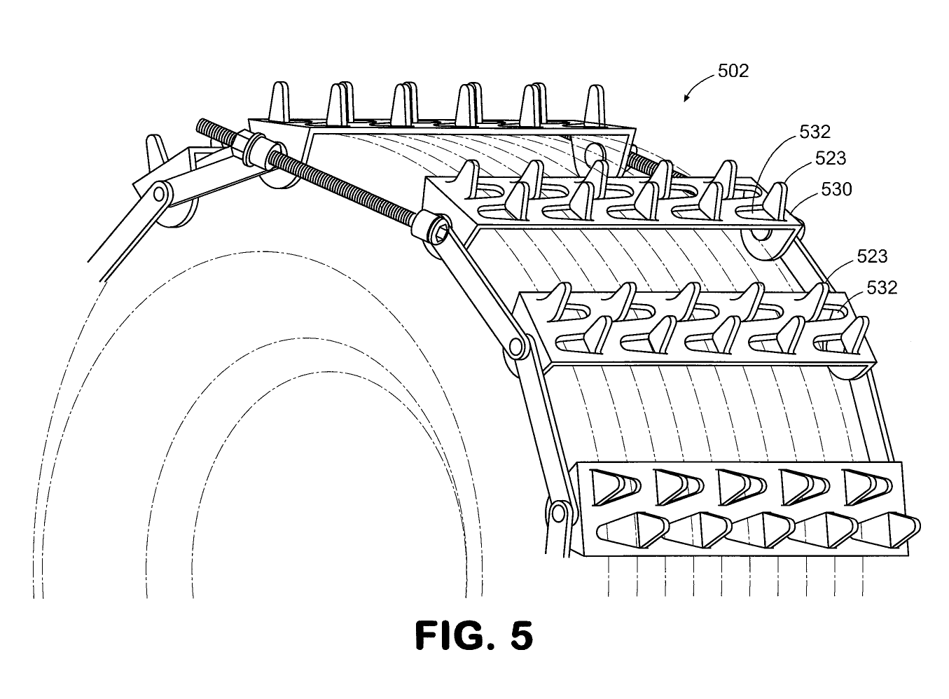

FIG. 5 shows one embodiment of the aerating apparatus 502. In the illustrated embodiment, the studs 523 may be fabricated by cutting the aerating portion 530 and bending the cut portions 532 of the aerating portion 530 outward so that a stud 523 is formed.

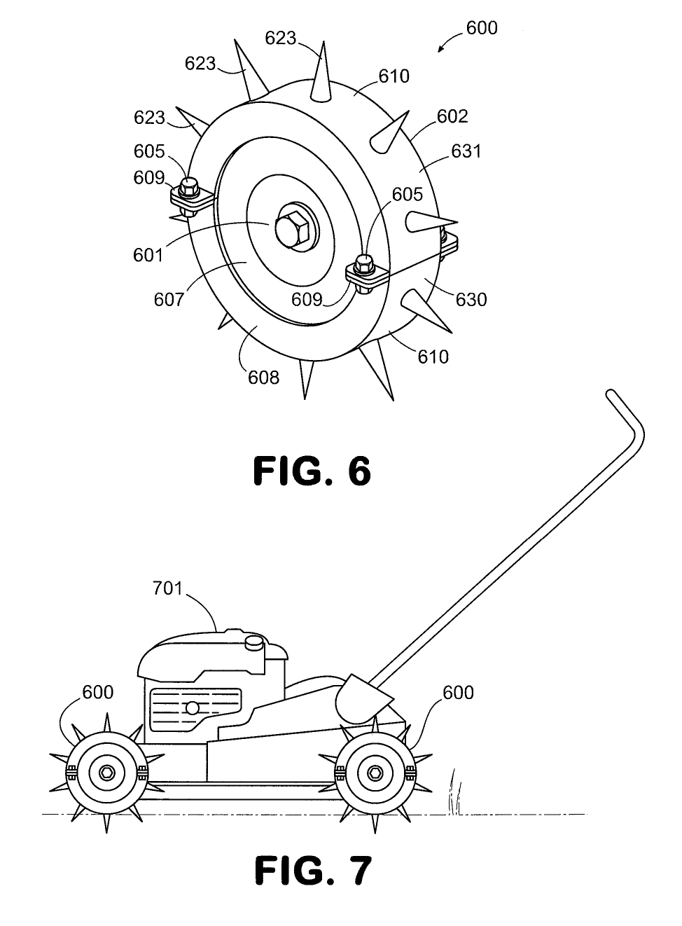

FIG. 6 shows an embodiment of an aerating system 600. The aerating apparatus 602 includes two aerating members 610. The aerating members 610 have aerating portions 630. Inner surfaces (not shown) of the aerating portions 630 contact the tread surface (not shown) of a wheel 601, and side wall portions 608 of the aerating members 610 contact the side wall 607 of the wheel 601. The aerating members 610 are secured to the wheel 601 by fasteners 605 that are inserted into holes (not shown) in flange portions 609. Studs 632 are attached to the outer surface 631 of the aerating portions 630.

One skilled in the art would understand that the studs 632 may be fabricated in the same manner as the studs illustrated in FIG. 5, and discussed above.

FIG. 7 shows an embodiment of an aerating system 600 using a push-type lawnmower 701.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A system for aerating soil comprising:
a plurality of aerating members, each of the aerating members having:
two opposing end portions and an aerating portion,
the end portions of the aerating members being angled with respect to the aerating portion;
a plurality of linking members moveably coupled with fasteners to the end portions such that an alternating series of linking members and aerating members form a loop of such members for attaching to a tire;
a plurality of stud members attached to the aerating portion of the aerating members.

2. The aerating system of claim 1, wherein at least two of the linking members are threaded linking members.

3. The aerating system of claim 1, wherein the stud members are spikes for aerating soil.

4. The aerating system of claim 1, further comprising:
means for aerating soil.

5. The system of claim 1, further comprising a lawn mower; and wherein the aerating apparatus engages a wheel of the lawnmower.

6. The aerating system of claim 1, wherein the studs are removable.

7. The aerating system of claim 1, wherein the end portions of the aerating members angled substantially perpendicular to the aerating portion.

8. The aerating system of claim 1, wherein the end portions define a hole operative to engage a fastener.

9. The aerating system of claim 1, wherein the aerating portion further comprises a plurality of perforations, wherein each perforation defines one of the plurality of stud members.

10. An aerating system comprising:
a lawnmower having a plurality of wheels, each of the wheels having a tread surface and side wall surfaces;
an aerating apparatus engaging one of the plurality of wheels;
the aerating apparatus comprising a plurality of aerating members, each aerating member having end portions, an inner surface and an outer surface;
the inner surfaces in contact with the tread surfaces, the end portions in contact with the side wall surfaces;
the aerating members moveably coupled with a plurality of linking members and fasteners;
a plurality of stud members attached to the outer surface of the aerating members.

11. The aerating system of claim 10, wherein at least two of the linking members are threaded linking members.

12. The aerating system of claim 10, wherein the stud members are spikes for aerating soil.

13. The aerating system of claim 10, wherein the lawnmower is a riding lawnmower.

14. The aerating system of claim 10, wherein the studs are removable.

15. The aerating system of claim 10, wherein the aerating portion further comprises a plurality of perforations, wherein each perforation defines one of the plurality of stud members.

16. An aerating system for use with a lawnmower having a plurality of wheels, each of the wheels having a tread surface and side wall surfaces, said aerating system comprising:
an aerating apparatus comprising:
two aerating members, each aerating member including:
an aerating portion, the aerating portion having an inner surface and an outer surface;
a plurality of stud members attached to the outer surface of the aerating portion;
side wall portions;
a plurality of fasteners; and
a plurality of flange portions defining holes operative to engage the fasteners;
wherein the aerating apparatus engages one of the plurality of wheels, the side wall portions in contact with the side wall surfaces and the inner surface of the aerating portion in contact with the tread surface.

17. The aerating system of claim 16, wherein the stud members are spikes for aerating soil.

18. The aerating system of claim 16, wherein the studs are removable.

19. The aerating system of claim 16, wherein the aerating portion further comprises a plurality of perforations, wherein each perforation defines one of the plurality of stud members.
